(19) United States
(12) Patent Application Publication
(10) Pub. No.: US 2017/0069982 A1
(43) Pub. Date: Mar. 9, 2017

(54) COAXIAL CABLE CONNECTOR

(71) Applicant: Corning Optical Communications RF LLC, Glendale, AZ (US)

(72) Inventors: Donald Andrew Burris, Peoria, AZ (US); Jimmy Valentin Falster, Vordingborg (DK); Michael Ole Matzen, Vordingborg (DK); Michael Meister, Langebaek (DK); Thomas Dewey Miller, Peoria, AZ (US)

(21) Appl. No.: 14/844,592

(22) Filed: Sep. 3, 2015

(51) Int. Cl. H01R 9/05; H01R 43/16

(52) U.S. Cl. CPC H01R 9/05; H01R 43/16

(57) ABSTRACT

Connectors and methods for attaching connectors to one or more cables and/or conduits are disclosed. The disclosed connectors and methods may secure an outer surface of the cable (e.g., an outer jacket of a cable) or conduit. A connector, for example, may include a coupler comprising an inner surface defining an coupler inner bore; a retainer comprising an inner surface defining a retainer inner bore configured to receive the inner conductor and insulator layer of a coaxial cable and an outer angled rear facing surface configured to extend between the insulator layer and the outer conductor layer of the coaxial cable, the retainer disposed within the inner bore of the coupler; a hub engaged to the retainer and disposed at least partially within the inner bore of the coupler, the hub rotatably engaged with the coupler, the hub further comprising an outer angled forward facing surface at least partially opposing the outer angled rear facing surface of the retainer, wherein the outer angled rear facing surface of the retainer and the outer angled forward facing surface of the hub are configured to secure the outer conductor layer between the outer angled rear facing surface of the retainer and the outer angled forward facing surface of the hub.

### BACKGROUND

Field

The present disclosure generally relates to coaxial cable connectors, and, more particularly, to coaxial connectors and cables assemblies with conductor retaining members.

Technical Background

Coaxial cable connectors, such as F-connectors, are used to attach coaxial cables to another object such as an appliance or junction having a terminal adapted to engage the connector. For example, F-connectors are often used to terminate a drop cable in a cable television system. The coaxial cable typically includes an inner conductor surrounded by a dielectric layer, which is in turn surrounded by a conductive grounding foil and/or braid defining an outer conductive grounding sheath. The outer conductive grounding sheath is itself surrounded by a protective outer jacket. The F-connector is typically secured over a prepared end of the jacketed coaxial cable, allowing the end of the coaxial cable to be connected with a terminal block, such as by a threaded connection with a threaded terminal of a terminal block.

Crimp style F-connectors including a crimp sleeve as part of a connector body are known. A special radial crimping tool, having jaws that form a hexagon, is typically used to radially crimp the crimp sleeve around the outer jacket of the coaxial cable to secure the crimp style F-connector over the prepared end of the coaxial cable.

Still another form of F-connector uses a radial compression sleeve to secure the F-connector over the prepared end of the cable. Rather than crimping a crimp sleeve radially toward the jacket of the coaxial cable, these F-connectors employ a plastic annular compression sleeve that is mounted inside of the F-connector. The compression sleeve includes an inner bore that is driven radially inwardly by a connector body when the annular compression sleeve is moved from a starting position to an ending position by means of an axial compression tool. The end of the coaxial cable is prepared by removing a portion of the outer braid and/or folding the outer braid back over the cable jacket. The F-connector itself is then inserted over the prepared end of the coaxial cable.

The step of flaring and folding the braided outer conductive grounding sheath over the outer jacket can be a time consuming and painstaking process. Further, small fragments of the outer braid may break off. These small fragments may cause electrical shorts in nearby electrical systems and/or enter the skin of cable installer.

Accordingly, alternative connectors that do not require that the braided outer conductive grounding sheath be folded over the jacket may be desired.

### SUMMARY

Embodiments of coaxial cable connectors that may be connected to a coaxial cable without requiring that a braided outer conductive grounding sheath be folded back over an outer jacket layer of the coaxial cable are provided.

In some embodiments, for example, an electrically conductive retainer is configured to contact and retain the cable braided outer conductive grounding sheath within a coaxial cable connector upon insertion of a coaxial cable into the connector and a subsequent compression of said connector. In one example embodiment, for example, a conductive retainer of a coaxial cable connector is configured to contact and axially clamp a braided outer conductive grounding sheath within the connector to retain the braided outer conductive grounding sheath within the connector and provide an electrical ground path from the braided outer conductive grounding sheath to a retainer and associated components of the coaxial cable connector.

In an example embodiment, for example, a coaxial cable connection is configured to provide a continual ground path from a cable outer conductor grounding structure to a rotatable coupler of the connector. In other particular embodiment, for example, a protrusion member extends from a retainer of a coaxial cable connector and is interposed in an end-wise fashion between a foil outer conductor layer of the coaxial cable and the braided outer conductive grounding sheath. In other example embodiments, a push-on type connector interface is incorporated to engage a mating port without the use of a rotatable coupler. Embodiments of coaxial cable connectors may also be configured to position a cable core and electrically tune the connector/cable coaxial structure.

In one embodiment, for example, a connector, for example, may include a coupler comprising an inner surface defining an coupler inner bore; a retainer comprising an inner surface defining a retainer inner bore configured to receive the inner conductor and insulator layer of a coaxial cable and an outer angled rear facing surface configured to extend between the insulator layer and the outer conductor layer of the coaxial cable, the retainer disposed within the inner bore of the coupler; a hub engaged to the retainer and disposed at least partially within the inner bore of the coupler, the hub rotatably engaged with the coupler, the hub further comprising an outer angled forward facing surface at least partially opposing the outer angled rear facing surface of the retainer, wherein the outer angled rear facing surface of the retainer and the outer angled forward facing surface of the hub are configured to secure the outer conductor layer between the outer angled rear facing surface of the retainer and the outer angled forward facing surface of the hub.

In another embodiment, a method for securing a cable or conduit in a connector is provided. The method includes inserting a coaxial cable through inner bores of a collar, a gripping member, a body and a hub. An inner conductor and insulator of the coaxial cable extend through a retainer. An outer conductor of the coaxial cable extends between the retainer and the hub along a rearward facing edge of the retainer. The method also includes sliding the collar relative to the body. The collar includes a surface extending inwardly from an inner surface of the collar. The surface is disposed adjacent to and contacting a rear end of the gripping member. The collar surface pushes the gripping member at least partially into a rear end of the body.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate embodiments, and together with the description serve to explain principles and operation of the various embodiments.

### BRIEF DESCRIPTION OF THE DRAWINGS

FIG. 1 schematically depicts a partial cross section of an example coaxial cable connector;

FIG. 2 schematically depicts a partial cross section of a coaxial cable;

FIG. 2A schematically depicts a cross sectional view of an example of a prepared coaxial cable;

FIG. 2B schematically depicts a cross sectional view of another example of a prepared coaxial cable;

FIG. 3 schematically depicts a cross sectional view of an example coaxial cable connector according to one or more embodiments described and illustrated herein;

FIG. 4 schematically depicts a cross sectional view of the example coaxial cable connector depicted in FIG. 3 with a coaxial cable prepared as shown in FIG. 2A partially inserted therein according to one or more embodiments described and illustrated herein;

FIG. 5 schematically depicts a cross sectional view of the example coaxial cable connector depicted in FIG. 3 with a coaxial cable fully inserted therein according to one or more embodiments described and illustrated herein;

FIG. 6A schematically depicts a cross sectional view of the example coaxial cable connector depicted in FIG. 3 with a coaxial cable fully inserted therein and the connector partially compressed according to one or more embodiments described and illustrated herein;

FIG. 6B schematically depicts a cross sectional view of the example coaxial cable connector depicted in FIG. 3 with a coaxial cable fully inserted therein and the connector further partially compressed according to one or more embodiments described and illustrated herein;

FIG. 6C schematically depicts a cross sectional view of the example coaxial cable connector depicted in FIG. 3 with a coaxial cable fully inserted therein and the connector even further partially compressed according to one or more embodiments described and illustrated herein;

FIG. 7 schematically depicts a cross sectional view of the example coaxial cable connector depicted in FIG. 3 with a coaxial cable fully inserted therein and the connector fully compressed according to one or more embodiments described and illustrated herein;

FIG. 8 schematically depicts a cross sectional view of another example coaxial cable connector providing an alternative coupling nut configuration according to one or more embodiments described and illustrated herein;

FIG. 9 schematically depicts a cross sectional view of yet another example coaxial cable connector providing an alternative coupling nut configuration and an O-ring according to one or more embodiments described and illustrated herein;

FIG. 10 schematically depicts a cross sectional view of another example coaxial cable connector providing an alternative coupling nut configuration and a body comprising an integral sealing feature according to one or more embodiments described and illustrated herein;

FIG. 11 schematically depicts a cross sectional view of yet another example coaxial cable connector comprising a conductive retainer having an alternative internal lip configuration according to one or more embodiments described and illustrated herein;

FIG. 12 schematically depicts a cross sectional view of another example coaxial cable connector comprising a hub having an integral continuity feature according to one or more embodiments described and illustrated herein;

FIG. 13 schematically depicts a cross sectional view of yet another example coaxial cable connector comprising a hub having an integral continuity feature and further comprising an alternative coupling nut configuration and an O-ring according to one or more embodiments described and illustrated herein;

FIG. 14 schematically depicts a cross sectional view of another example coaxial cable connector comprising a conductive retainer including a protrusion member extending from the retainer and interposed in an end-wise fashion between a foil outer conductor layer of a coaxial cable and a braided outer conductive grounding sheath according to one or more embodiments described and illustrated herein;

FIG. 15 schematically depicts a cross sectional view of the example coaxial cable connector of FIG. 14 having a coaxial cable at least partially installed according to one or more embodiments described and illustrated herein;

FIG. 16A schematically depicts a partial cross sectional view of an example hub configured to prevent or impede rotation within a mating body according to one or more embodiments described and illustrated herein;

FIG. 16B schematically depicts an external view of an another example hub configured to prevent or impeded rotation within a mating body according to one or more embodiments described and illustrated herein;

FIG. 17A schematically depicts a partial cross sectional view of an example hub mounted within a mating body of a coaxial cable connector according to one or more embodiments described and illustrated herein;

FIG. 17B schematically depicts a partial cross sectional view of the example hub depicted in FIG. 17A mounted within a mating body of the coaxial cable connector and having an end flared according to one or more embodiments described and illustrated herein;

FIG. 17C schematically depicts a partial cross sectional view of another example hub mounted within a mating body of a coaxial cable connector according to one or more embodiments described and illustrated herein;

FIG. 17D schematically depicts a partial cross sectional view of the example hub depicted in FIG. 17C mounted within a mating body of a coaxial cable connector and having an end flared according to one or more embodiments described and illustrated herein;

FIG. 18 schematically depicts a cross sectional view of yet another example coaxial cable connector at least partially comprising a push-on type connector interface configured to engage a mating port without the use of a rotatable coupler according to one or more embodiments described and illustrated herein;

FIG. 19 schematically depicts a cross sectional view of another example coaxial cable connector at least partially comprising a unitary rear collar according to one or more embodiments described and illustrated herein;

FIG. 20 schematically depicts a cross sectional view of the example coaxial cable connector depicted in FIG. 19 with a coaxial cable partially inserted therein according to one or more embodiments described and illustrated herein; and

FIG. 21 schematically depicts a cross sectional view of another example coaxial cable connector at least partially comprising a unitary rear collar having a hinged portion according to one or more embodiments described and illustrated herein.

### DETAILED DESCRIPTION

Embodiments of coaxial cable connectors configured to be installed on a coaxial cable having limited preparation performed on the coaxial cable are provided. In some embodiments, for example, the coaxial cable connectors do not require that an outer conductor layer, such as a braided outer conductive grounding sheath (braid), of the coaxial cable be folded back over an outer jacket of the coaxial cable. Various embodiments of connectors and coaxial cable assemblies are described in detail below.

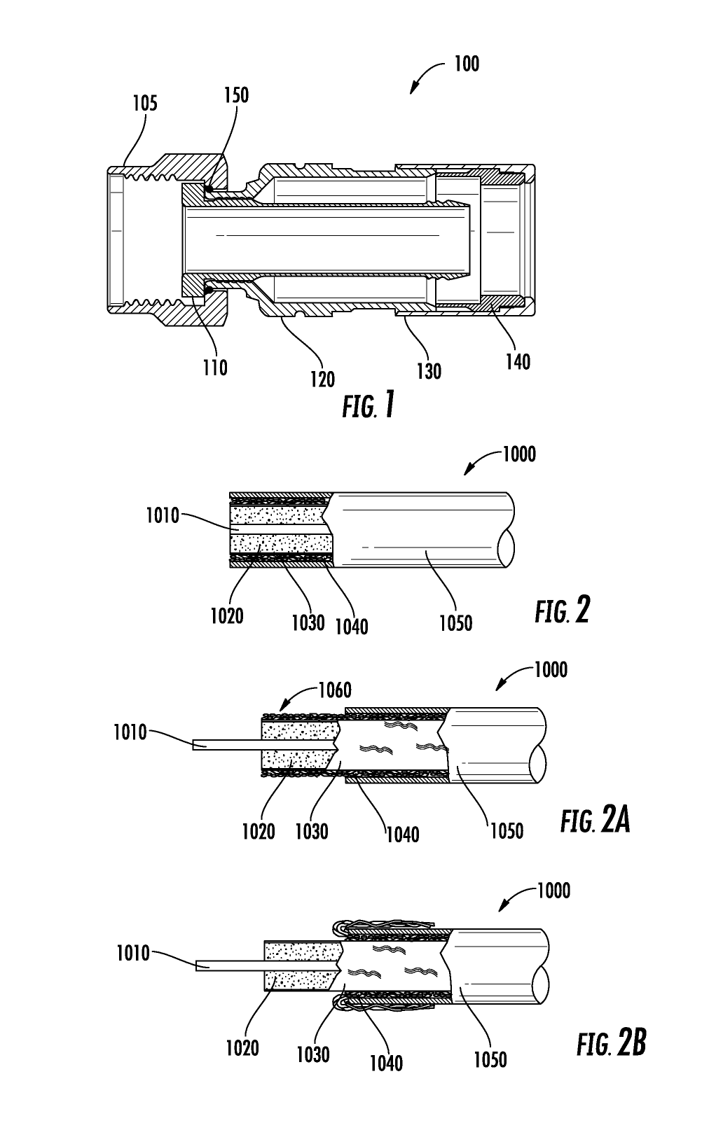

Referring now to FIG. 1 wherein FIG. 1 schematically depicts a partial cross section of an example coaxial cable connector 100. In this particular example, the coaxial cable connector 100 includes a coupler 105 rotatably engaged about a shoulder of a separate post 110. The coaxial cable connector 100 further includes a body 120 disposed at least partially around the post 110. In the coaxial cable connector 100, a collar 130 is disposed at least partially around an end of the body 120 and a gripping member 140 is disposed between the collar and body as shown in FIG. 1. The coupler 105, for example, may be made of metal such as brass and plated with a conductive material such as nickel. The post 110 may be made of metal such as brass and plated with a conductive material such as tin. The body 120 may be made of metal such as brass and plated with a conductive material such as nickel. An O-ring 150 may also be disposed between the coupler 105 and body 120 as shown in FIG. 1 to seal the connector. In one example, the coaxial cable connector is a commercially available coaxial cable connector known as an UltraRange Type F connector produced by Corning Optical Communications RF and described in U.S. Pat. No. 7,018,23 and U.S. Pat. No. 7,182,639.

FIG. 2 illustrates an example coaxial cable 1000 schematically illustrated in a partial cutaway view. The example coaxial cable 1000 comprises an inner conductor 1010 surrounded by an insulator layer 1020. In some embodiments the inner conductor 1010 is copper-clad aluminum, though the inner conductor 1010 may be a conductor other than copper-clad aluminum (e.g., copper, gold, or the like) in other embodiments. In some embodiments, the dielectric/insulator layer 1020 is a plastic, though the insulator layer 1020 may be an insulator other than plastic in other embodiments. The insulator layer 1020 may also have a foil or other metallic covering 1030 in some embodiments. The coaxial cable 1000 further comprises a braided outer conductor layer 1040 which is covered and protected by an outer layer 1050 (i.e., a cable jacket). In some embodiments, the covering 1030 and the outer conductor layer 1050 is aluminum, though the covering 1030 and/or the outer conductor layer 1050 may be a conductor other than aluminum in other embodiments. In some embodiments, the outer jacket 1050 is an insulator, such as, but not limited to plastic. The outer jacket 1050 may comprise, for example, polyethylene and/or other plastic.

FIG. 2A schematically illustrates a cross-sectional view of the example coaxial cable 1000 of FIG. 2 in which a stripped portion 1060 of the outer jacket 1050 of the coaxial cable 1000 is stripped from the coaxial cable 1000 resulting in the braided outer conductor layer 1040 being exposed.

FIG. 2B schematically illustrates a cross-sectional view of the example coaxial cable 1000 of FIGS. 2 and 2A in which a braided outer conductor layer 1040 exposed at the stripped portion 1060 of the coaxial cable 1000 is subsequently folded back over the cable jacket 1050. Folding back of cable braid 1040 is part of the current state of the art cable preparation method. The step of flaring and folding the braided outer conductive grounding sheath over the outer jacket can be a time consuming and painstaking process. Further, small fragments of the outer braid may break off. These small fragments may cause electrical shorts in nearby electrical systems and/or enter the skin of cable installer. As a result, embodiments of coaxial cable connectors are provided that may be installed on a cable prepared as illustrated in FIG. 2A and thus eliminate the need to further prepare the cable as described in FIG. 2B.

FIG. 3 schematically depicts a cross sectional view of an example coaxial cable connector 200 according to one or more embodiments described and illustrated herein. In this embodiment, the coaxial cable connector 200 at least partially comprises a coupler 300 configured to connect the coaxial cable connector to a terminal of an appliance or junction of a coaxial cable system. A retainer 400 is disposed at least partially within an inner bore of the coupler 300. A hub 500 is engaged with the retainer 400 and is also at least partially disposed within the inner bore of the coupler 300. A body 600 is disposed at least partially radially externally to a rearward portion of the hub 500 and includes an inner bore configured to receive a prepared end of a coaxial cable. A radially inwardly extending protrusion of the body 600 is configured to engage an annular groove of the hub 500. A collar 700 is disposed at least partially around a rear end of the body 600 and is configured to move axially around an outer surface of the body 600 as described in further detail below. As shown in FIG. 3, a gripping member 800 is disposed within an inner bore of the collar 700 and generally adjacent to a rear end of the body 600. FIG. 3 further shows a gasket 900 that may be used in some embodiments to provide a seal between the retainer 400 and the coupler 300.

In one embodiment, the coupler 300, retainer 400, hub 500 may be made from nickel plated brass or the like. The body 600 may be made from plastic such as acetal as a non-limiting example, or alternatively, nickel plated brass. Collar 700 may be made from plastic, or alternatively, nickel plated brass. Gripping member 800 may be made from plastic such as acetal as a non-limiting example. The gasket 900 may be made from EPDM or the like.

In the embodiment shown in FIG. 3, for example, the coupler 300 comprises an inner surface 302 defining a longitudinal inner bore 304 extending through the coupler 300 from a first forward end 306 to a second rearward end 308. In this particular embodiment, for example, the inner surface 302 of the coupler 300 further comprises threads 310 extending at least partially along the inner surface 302 such that the coupler is configured to rotatably engage the terminal of the appliance or junction of the coaxial cable system, wherein the coupler 300 may be referred to as a nut, although in other implementations the coupler may be configured to slidably engage the terminal. The rear end 308 of the coupler 300 comprises a tail flange 312. The tail flange 312 comprises a forward facing portion 314 configured to axially engage a flange of the hub 500, thereby preventing the coupler 300 from axially sliding off the front end of the hub 500 and retainer 400.

The retainer 400 comprises a first forward end 403 and a second rearward end 404. An inner surface of the retainer 400 defines a longitudinal bore extending through the retainer 400 and is configured to receive a prepared end of a coaxial cable. In the embodiment shown in FIG. 3, for example, the retainer 400 comprises an annular groove 402 configured to receive a radial protrusion 502 of the hub 500 to rotatably or non-rotatably engage the retainer 400 to the hub 500. The coupled retainer 400 and hub 500 extend at least partially into the inner bore of the coupler 200 and extend in a second rearward direction from the coupler 300. The hub 500 comprises a first forward end 512 and a second rear end 514. The hub 500 further comprises an inner surface 508 defining a longitudinal inner bore extending through the hub from the first forward end 512 to the second rear end 514. The hub 500 also comprises a rearward facing wall 504 configured to rotatably or non-rotatably engage a forward facing face 314 of the flange 312 of the coupler 300 that extends radially inwardly from an outer surface of the coupler 300 and prevents the coupler 300 from moving forwardly relative to the retainer 400 and the hub 500.

As is shown in FIG. 7, the retainer 400 and hub 500 each comprise generally opposing angled surfaces 408 and 516 of the retainer 400 and hub 500, respectively. The generally opposing angled surfaces 408 and 516 together define a gap disposed between the surfaces 408 and 516 configured to receive and engage an outer conductor layer (e.g., braided outer conductor layer) of a prepared end of a coaxial cable inserted into the coaxial cable connector 200 (see, e.g., FIG. 7).

The body 600 comprises a first forward end 602 and a second rearward end 604, and an inner surface 606 defining a longitudinal inner bore 608 extending through the body from the first end 602 to the second end 604. The body further comprises a flange 610 disposed generally at the first forward end 602 extending radially inwardly to rotatably or non-rotatably engage an annular groove 506 of the hub 500. The body also includes a first forward shoulder 612 and a second rearward shoulder 614 each extending radially outwardly from an outer surface 616 of the body 600. The outer surface 616 extends longitudinally between the first forward shoulder 612 and the second rearward shoulder 614. The first forward shoulder 612 and the second rearward shoulder 614 are configured to engage an inwardly extending flange 710 of the collar 700 to limit movement of the collar 700 in a first forward direction and a second rearward direction, respectively. In the particular embodiment shown in FIG. 3, for example, the first forward shoulder 612 includes a forward facing surface 613 configured to engage the inwardly extending flange 710 of the collar such that the flange 710 is configured to slide over the first forward shoulder 612 and latch over the first forward shoulder 612 at the forward facing surface 613 when the collar 700 is compressed over the body 600 and holding the collar 700 and body in the compressed configuration. The second rearward shoulder 614, for example, is configured to prevent the collar 700 from sliding off the rear end 604 of the body 600.

The collar 700 comprises a first forward end 702, a second rearward end 704 and an inner surface 706 defining a longitudinal inner bore 708 extending through the collar 700 from the first end 702 to the second end 704. The body further comprises a flange 710 disposed generally at the first forward end 702 extending radially inwardly to slidably engage the outer surface 616 of the body 600. The flange 710 is configured to slide along the outer surface 616 of the body between the first forward shoulder 612 and the second rearward shoulder 614, each of which acts as a stop for the relative movement of the body 600 and collar 700 in the first forward and second rearward directions, respectively. Further, in the particular embodiment shown in FIG. 3, for example, the first forward shoulder 612 includes a forward facing surface 613 configured to engage the inwardly extending flange 710 of the collar such that the flange 710 is configured to slide over the first forward shoulder 612 and latch over the first forward shoulder 612 at the forward facing surface 613 when the collar 700 is compressed over the body 600 and holding the collar 700 and body in the compressed configuration.

The gripping member 800 comprises a first forward end 802, a rearward end 804 and an inner surface 806 defining a longitudinal inner bore 808 extending through the gripping member 800 from the first end 802 to the second end 804. The gripping member 800 is disposed within the longitudinal inner bore 708 of the collar 700 between and generally adjacent to the rear end 604 of the body 600 and an internal radially inwardly extending surface 712 of the collar 700. As described in more detail below, the gripping member 800 is configured to be driven into the longitudinal inner bore 608 of the body 600 by the radially inwardly extending surface 712 of the collar 700 as the collar is slid in a forward direction relative to the body 600. U.S. Pat. No. 7,182,639 issued on Feb. 27, 2007 further describes example gripping members that may be used within the design of a coaxial cable connector and is incorporated by reference in its entirety as if fully set forth herein.

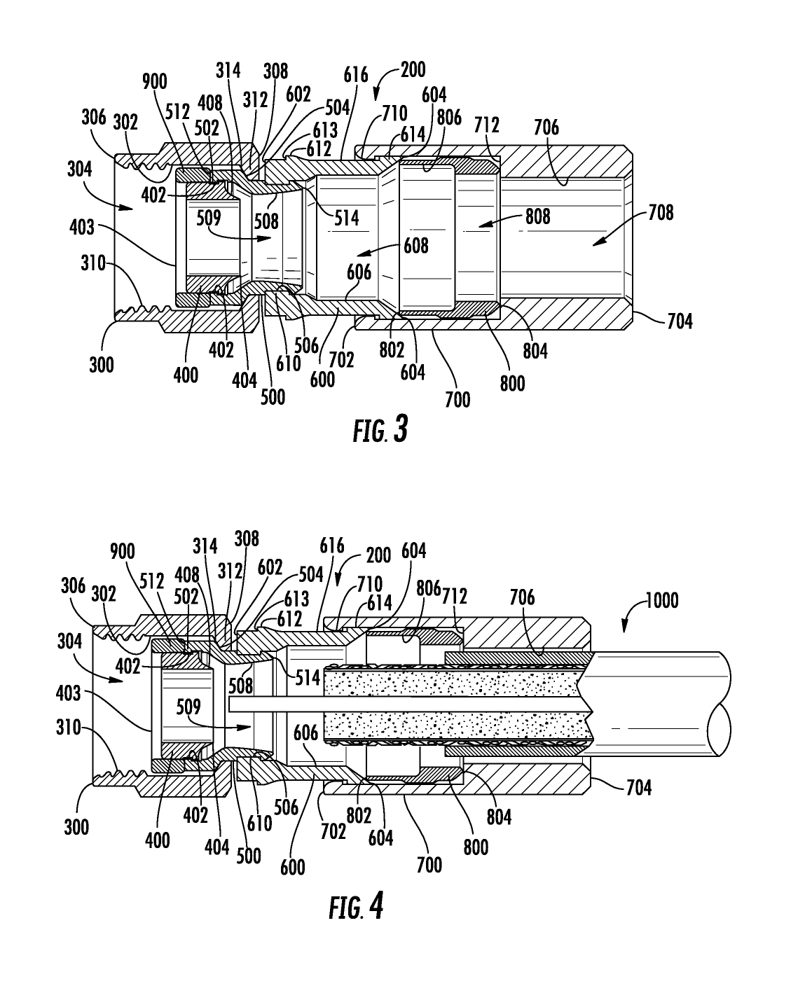

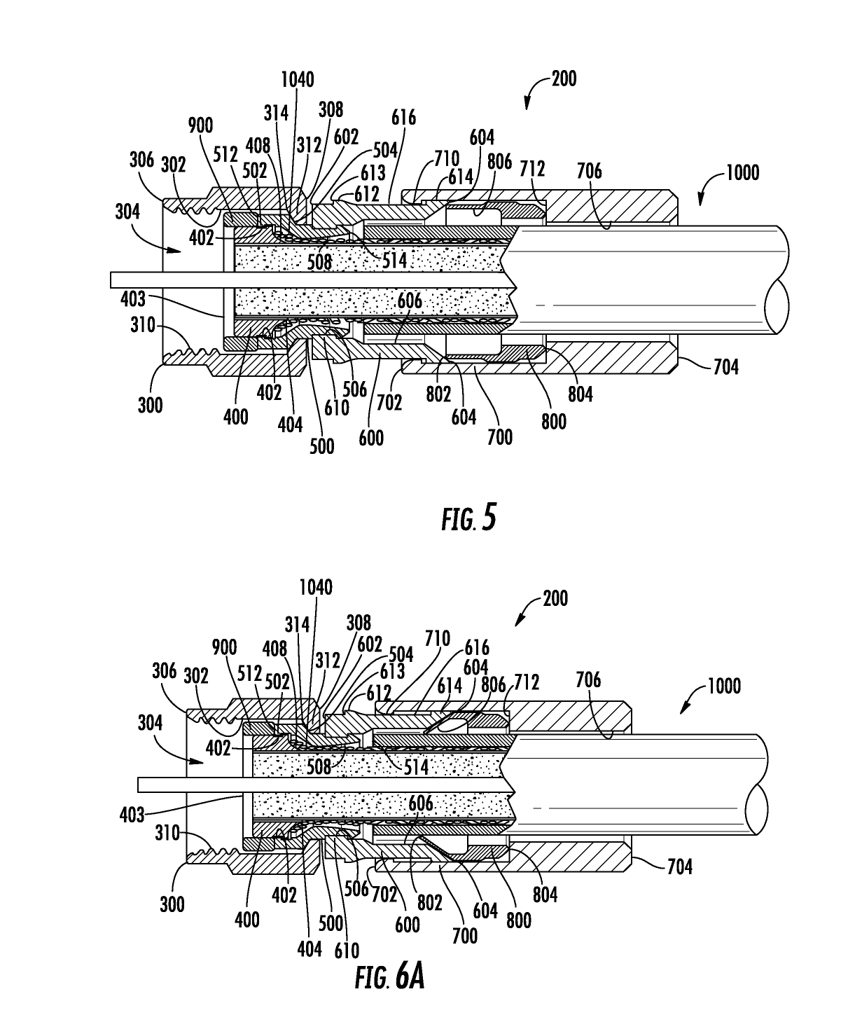

FIG. 4 schematically depicts a cross sectional view of the example coaxial cable connector 200 depicted in FIG. 3 with a coaxial cable 1000 prepared as shown in FIG. 2B and at least partially inserted. Preparation as illustrated in FIG. 2A is significantly easier and quicker to accomplish as compared to FIG. 2B as folding back of braid 1040 is not required.

FIG. 5 schematically depicts a cross sectional view of the example coaxial cable connector 200 depicted in FIGS. 3 and 4 with the coaxial cable 1000 fully inserted therein. The inner conductor 1010 surrounded by an insulator layer 1020, a metallic covering 1030, a braided outer conductor layer 1040 and an outer jacket 1050, which has been stripped from the end of the coaxial cable as described above with reference to FIG. 2A. The inner conductor 101, insulator layer 1020 and metallic covering 1030 are inserted into inner bore of retainer 400 while braided outer conductor layer 1040 is arrayed along tapered surface of retainer 400. The braided outer conductor layer 1040 is disposed in an annular gap defined between the angled surfaces 408 and 516 of the retainer 400 and the hub 500, respectively.

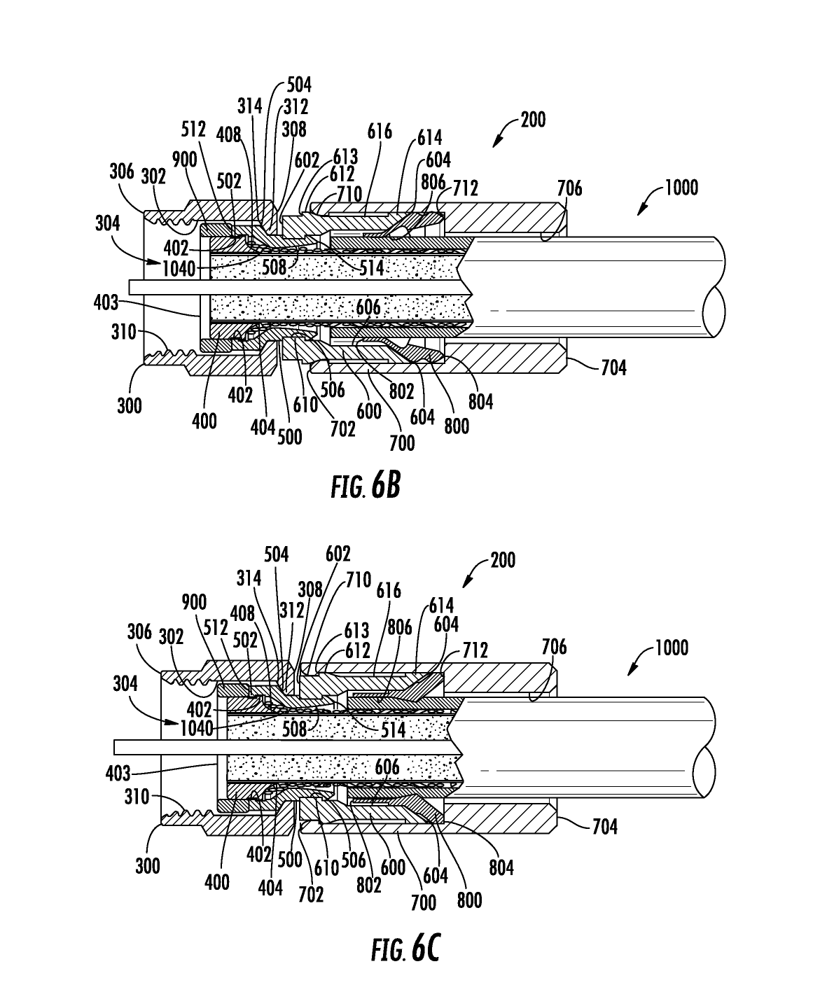

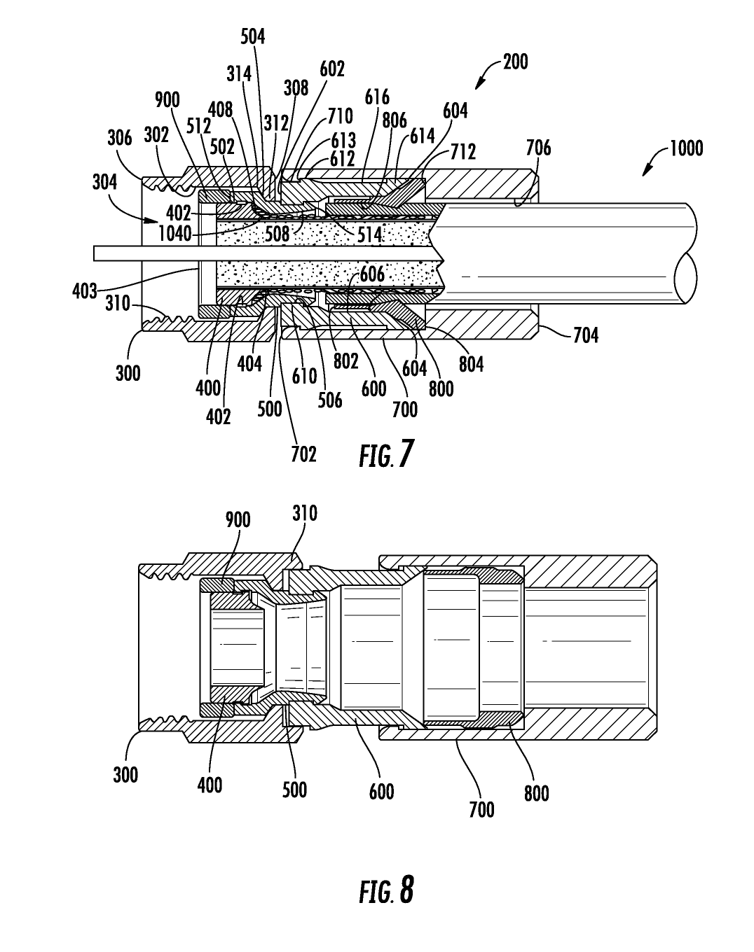

FIG. 6A schematically depicts a cross sectional view of the example coaxial cable connector 200 depicted in FIGS. 3-5 with a coaxial cable 1000 fully inserted therein and the connector 200 partially compressed. In this embodiment, the collar 700 is moved axially forward toward the front of connector 200, such as by means of one or more industry standard compression tools (not shown). As shown in FIG. 6A, the flange 710 of the collar 700 is slid along the outer surface 616 of the body 600 between the first forward shoulder 612 and the second rearward shoulder 614. The gripping member 800 is driven at least partially inside body 600 by the axial movement of the radially inwardly extending surface 712 of the collar 700, such as also described in U.S. Pat. No. 7,182,639 previously incorporated by reference.

FIG. 6B schematically depicts a cross sectional view of the example coaxial cable connector 200 depicted in FIGS. 3-6A with the coaxial cable 1000 fully inserted therein and the connector 200 further partially compressed. In FIG. 6B, the collar 700 is moved further axially forward toward the front of connector 200, again such as by means of one or more industry standard compression tools (not shown). In this example, the flange 710 of the collar 700 is slid up to the first forward shoulder 612 along the outer surface 616 of the body 600. As shown in FIG. 6B, the gripping member 800 is driven at least partially under body 600 by the axial movement of collar 700.

FIG. 6C schematically depicts a cross sectional view of the example coaxial cable connector 200 depicted in FIGS. 3-6B with a coaxial cable 1000 fully inserted therein and connector 200 even further partially compressed. In FIG. 6C, the collar 700 is moved yet further axially forward toward the front of connector 200, again such as by means of one or more industry standard compression tools (not shown). In FIG. 6C, the flange 710 of the collar 700 has been slid over the first forward shoulder 612 of the body and snapped or otherwise latched or engaged with the forward facing surface 613 of the first forward shoulder 612 of the body 600 to engage the collar 700 and body 600 in the compressed state shown in FIG. 6C. The gripping member 800 is driven as far as possible by collar 700 and at least partially under the body 600 by the axial movement of the collar 700 and engages the outer layer of the coaxial cable.

FIG. 7 schematically depicts a cross sectional view of the example coaxial cable connector 200 depicted in FIGS. 3-6C with a coaxial cable fully inserted therein and the connector 200 fully compressed. As shown in FIG. 7, the retainer 400 is driven further inside of the hub 500 trapping and compressing the braided outer conductor layer 1040 between the retainer 400 and the hub 500. The entrapment and compression of the braided outer conductor layer 1040 betwixt the generally opposing angled surfaces 408 and 516 of the retainer 400 and the hub 500, respectively, causes both electrical conduction and mechanical communication between the connector and the coaxial cable braided outer conductor structure 1050. Electrically, a reliable ground path is established between the connector interface and the cable while simultaneously mechanical retention of the cable within the connector is achieved.

In the particular embodiment shown in FIGS. 3-7, for example, the retainer 400 and hub 500 each comprise generally opposing angled surfaces 408 and 516 of the retainer 400 and hub 500, respectively. The generally opposing angled surfaces 408 and 516 together define a gap disposed between the surfaces 408 and 516 of the retainer 400 and hub 500, respectively. The generally opposing angled surfaces 408 and 516 are configured to receive and engage an outer conductor layer (e.g., braided outer conductor layer) of a prepared end of a coaxial cable inserted into the coaxial cable connector 200 within the gap and, as the retainer 400 is moved axially closer to the hub 500 (e.g., via a compression tool), the surfaces 408 and 516 reduce the size of the gap disposed between the surfaces of the retainer 400 and hub 500 and engage the outer conductor structure 1040 providing electrical and/or mechanical engagement between the outer conductor 1040 of the coaxial cable 1000 and the retainer 400 and/or hub 500 of the coaxial cable connector 200.

In FIG. 7, the retainer 400 is shown driven further inside the hub 500 such that the flange 502 of the hub 500 is pushed forward of the groove 402 of the retainer 400 and is pushed forward into and, in some embodiments, compressing the gasket 900 to provide a seal between the hub 500 and the gasket 900.

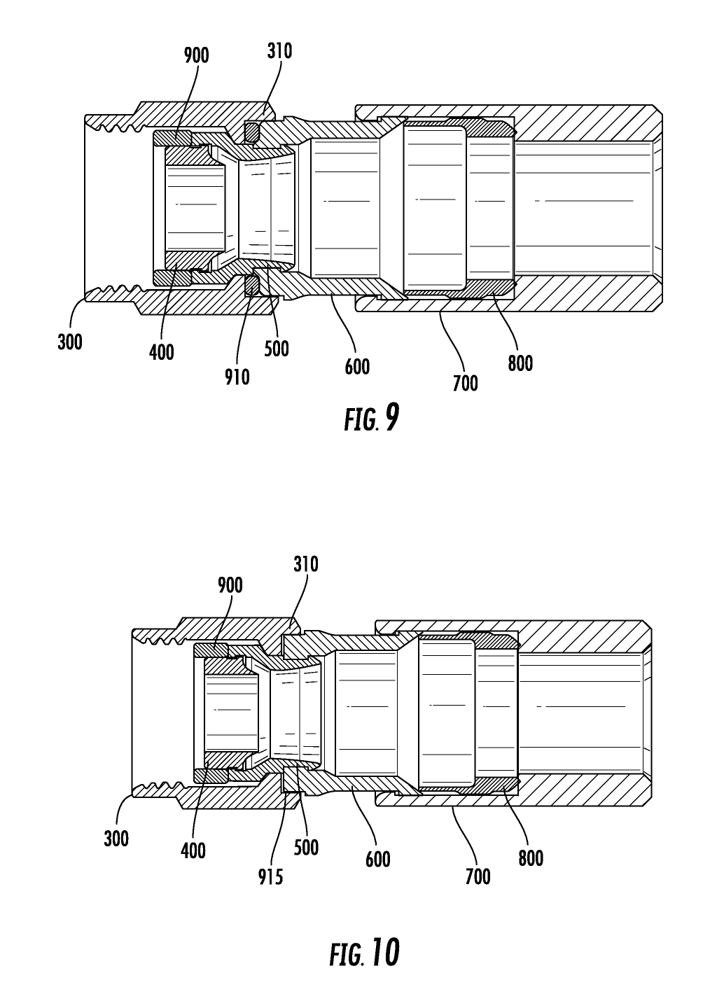

FIG. 8 schematically depicts a cross sectional view of an example coaxial cable connector providing an alternative coaxial cable connector configuration. In this embodiment, the coupler 300 of the coaxial cable connector further comprises an extended portion 310 that encircles at least a portion of body 600. Encirclement of the extended portion 310 of the coupler about body 600 increases the connector resistance to side-loading forces by reinforcing the mechanical joint between hub 500 and body 600.

FIG. 9 schematically depicts a cross sectional view of another example coaxial cable connector providing the alternative coupling nut configuration as described with reference to FIG. 8 and further comprises an O-ring 910 disposed between a rearward facing edge of the inwardly extending flange of the coupler 300 and a front facing inwardly extending face of the body 500 disposed at or near the front end 502 of the body 500. Examples of such an O-Ring configuration are further described in United States published patent application number 2011/0250789 filed on Apr. 11, 2011, which is incorporated by reference herein in its entirety

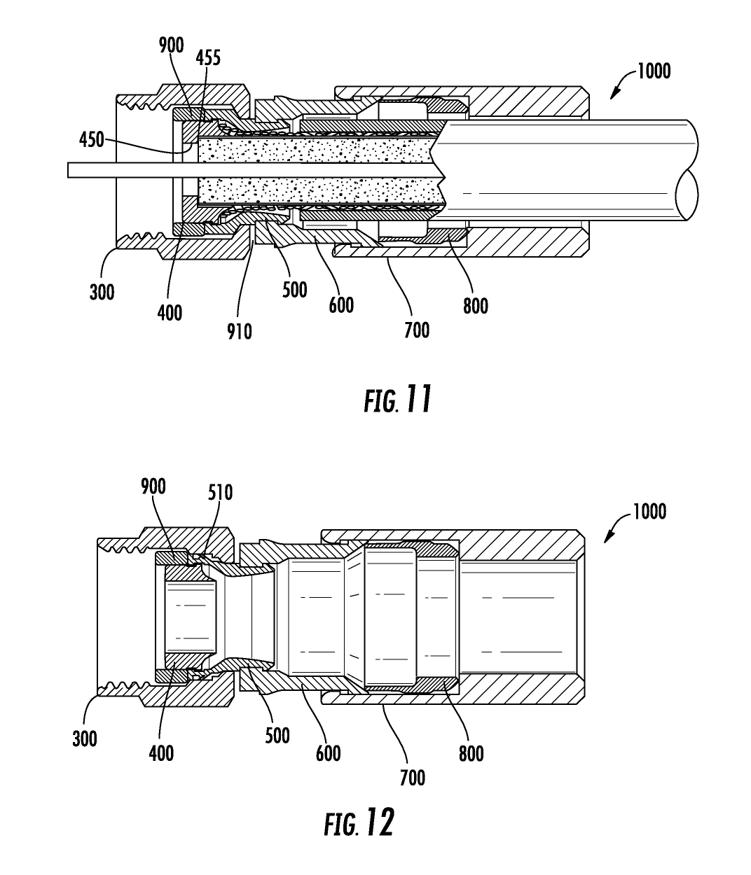

FIG. 10 schematically depicts a cross sectional view of yet another example coaxial cable connector providing the alternative coupler 300 configuration as described with reference to in FIG. 8. The coaxial cable connector and further comprises a body 600 having an integral sealing feature 915. In this embodiment, the integral sealing feature 915 includes a protrusion that provides an environmental seal with the counter bore of coupler 300, such as in embodiments wherein body 600 is made from a plastic material.

FIG. 11 schematically depicts a cross sectional view of another example coaxial cable connector. In this embodiment, the coaxial cable connector comprises a conductive retainer having an alternative internal lip 450. A rearward facing annular surface 455 of the internal lip 450 acts as a stop or seat to locate a cable core (including an inner conductor 1010, an insulator layer 1020 and metallic covering 1030) at a predetermined position making it possible to have cables of various structures (such as 60% braid, tri-shield and quad-shield cables) be located at a specific distance from the connector interface. The inner bore of retainer 400 may be adjusted to control the electrical impedance as related to cable center conductor 1010 to tune the connector interface for various electrical performance parameters.

FIG. 12 schematically depicts a cross sectional view of another example coaxial cable connector. In this embodiment, the coaxial cable connector comprises a hub 500 having an integral continuity feature 510. Such an integral continuity feature may include one or more integral continuity features such as described in U.S. patent application Ser. No. 13/652,969 filed on Oct. 16, 2012, which is incorporated by reference in its entirety as if fully set forth herein.

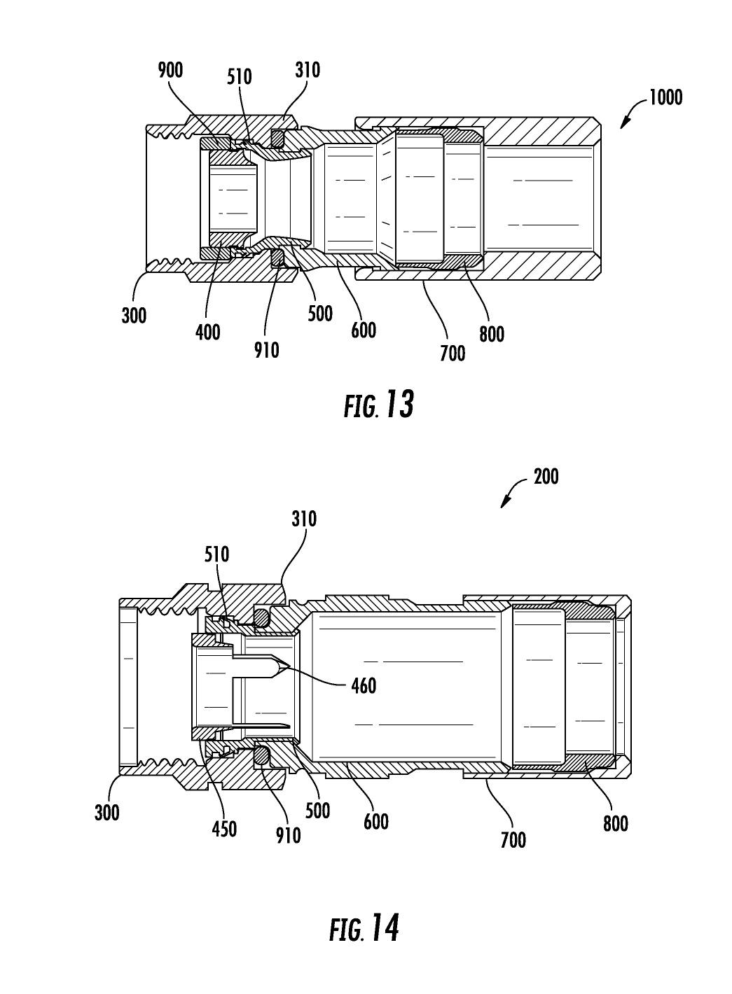

FIG. 13 schematically depicts a cross sectional view of yet another example coaxial cable connector. In this embodiment, the coaxial cable connector comprises a modified hub 500 structure including an integral continuity feature 510 and further comprising an alternative coupling nut configuration 310 and O-ring 910 as previously described with reference to FIG. 9.

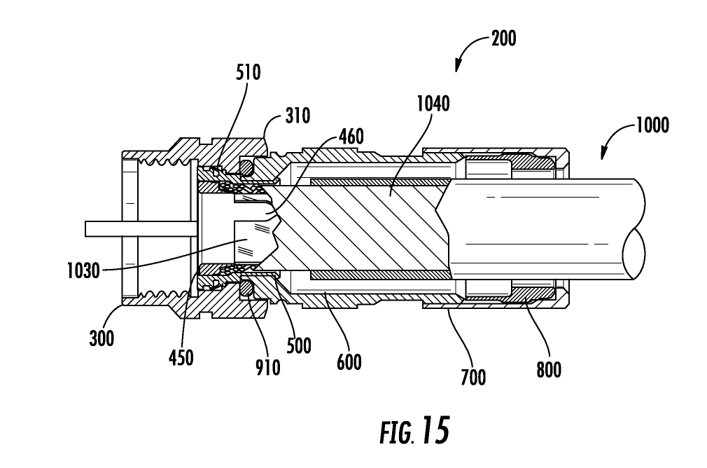

FIG. 14 schematically depicts a cross sectional view of another example coaxial cable connector. In this embodiment, the coaxial cable connector comprises a conductive retainer 450 having a protrusion member 460 extending from and as part of the retainer 450. The protrusion member 460 is interposed in an end-wise fashion between the foil outer conductor layer 1030 of the coaxial cable 1000 and the braided outer conductive grounding sheath 1040 as illustrated in FIG. 15.

FIG. 15 schematically depicts a partial cross sectional view of the example coaxial cable connector of FIG. 14. The coaxial cable connector comprises a conductive retainer 450 having protrusion member 460 extending from and as part of retainer 450. The conductive retainer 450 is interposed in an end-wise fashion between the foil outer conductor layer 1030 of the coaxial cable 1000 and the braided outer conductive grounding sheath 1040.

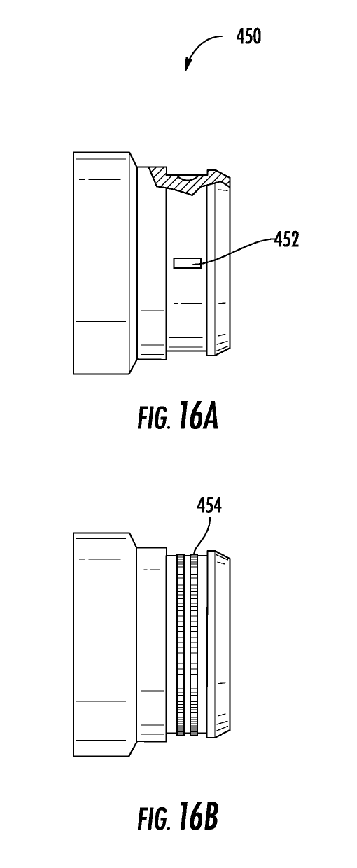

FIG. 16A schematically depicts a partial cross sectional view of an example hub 450. In this embodiment, the hub 450 comprises a plurality of blind slots 452 disposed along an outer edge of the hub 450. The blind slots 452 are configured to prevent or impede rotation of hub 450 within body 600. In this embodiment, the edges of the slots 452 are configured to engage the inner bore of body 600, such as in embodiments where body 600 is made from a plastic material.

FIG. 16B schematically depicts an external view of another example hub 450. In this embodiment, the hub 450 is configured to prevent or impede rotation of the hub 450′ within the body 600 via a knurled surface 454. Teeth of the knurled surface 454 are configured to engage the inner bore of body 600, such as in embodiments wherein body 600 is made from a plastic material.

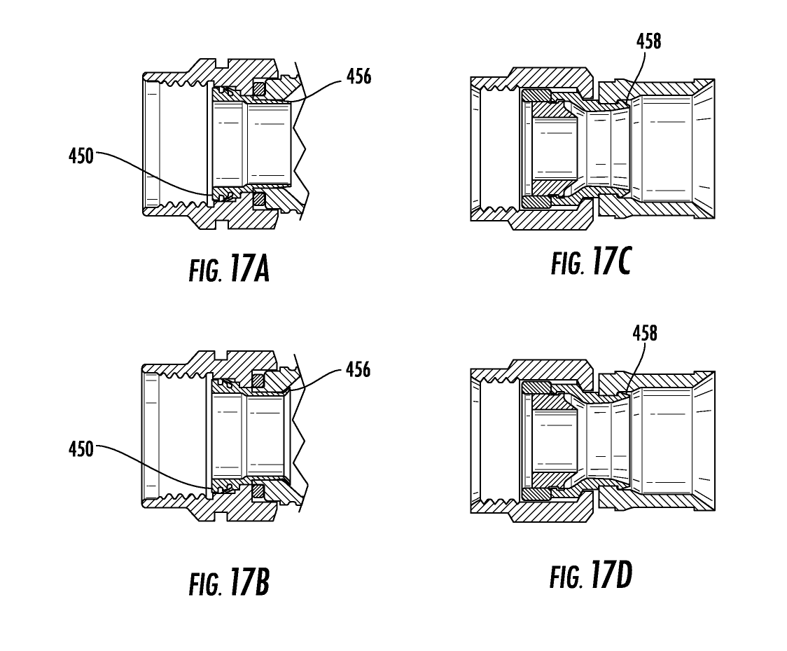

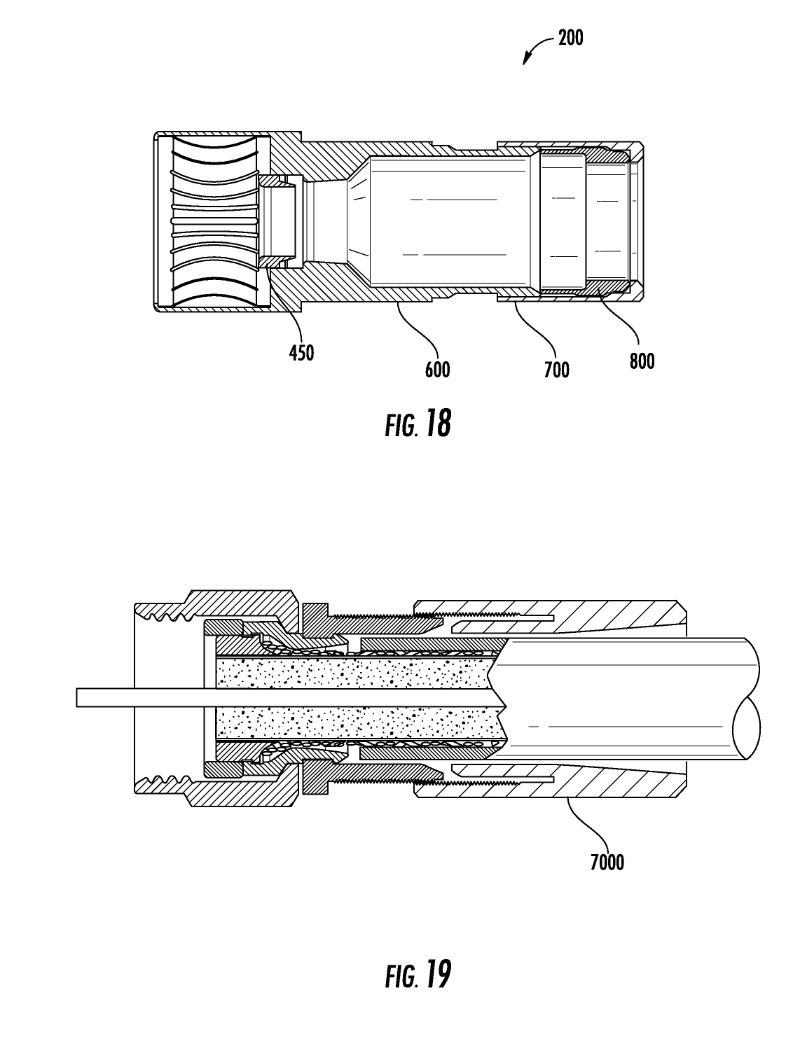

FIGS. 17A and 17B schematically depict partial cross sectional views of an example hub 450 mounted within a body 600. In FIG. 17A, the hub 450 is in a pre-flared condition such that the rear end 456 of the hub 450 extends generally longitudinally through a front opening of the body 600. In FIG. 17B, the hub 450 is mounted within body 600 and the hub 450 is in a flared condition 45x. In this embodiment, the flared rear end 456 serves to interlock hub 450 with body 600 for improved component retention.

FIGS. 17C and 17D schematically depict partial cross sectional views of another example hub 450 mounted within a body 600. In FIG. 17C, the hub 450 at least partially comprises a barb 458 and is in a pre-flared condition. In FIG. 17D, the hub 450 is mounted within body 600. The hub 450 is in a flared condition 458. The flare 458 serves to interlock hub 450 with the body 600 for improved component retention.

FIG. 18 schematically depicts a cross sectional view of yet another example coaxial cable connector 200. In this embodiment, the coaxial cable connector 200 at least partially comprises a push-on type connector interface incorporated to engage a mating port without the use of a rotatable coupler.

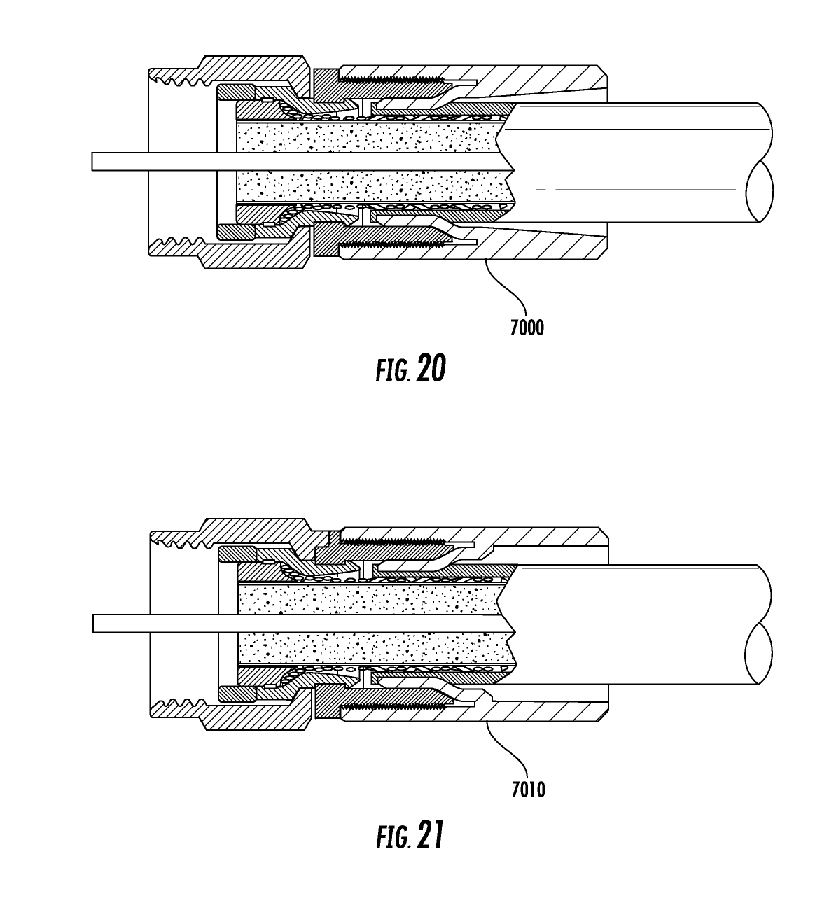

FIG. 19 schematically depicts a cross sectional view of another example coaxial cable connector. In this embodiment, the coaxial cable connector at least partially comprises a unitary rear collar 7000 in an open or uncompressed condition having a coaxial cable inserted. Examples of such a rear collar are provided in U.S. Pat. No. 5,879,191, which is incorporated by reference in its entirety as if fully set forth herein.

FIG. 20 schematically depicts a cross sectional view of the example coaxial cable connector at least partially comprising a unitary rear collar 7000 as depicted in FIG. 19 with a coaxial cable inserted and the connector in a closed or compressed condition. Again, examples of unitary rear collars that may be provided in a coaxial cable connector such as shown in FIG. 20 are provided in previously incorporated U.S. Pat. No. 5,879,191.

FIG. 21 schematically depicts a cross sectional view of another example coaxial cable connector at least partially comprising a unitary rear collar 7000 having a hinged portion similar to that as disclosed in previously incorporated U.S. Pat. No. 5,879,191 with a coaxial cable inserted and the connector in a closed or compressed condition.

It should now be understood that embodiments described herein are directed to connectors and methods for securing an outer layer of a cable or conduit within a connector.

For the purposes of describing and defining the subject matter of the disclosure it is noted that the terms “substantially” and “generally” are utilized herein to represent the inherent degree of uncertainty that may be attributed to any quantitative comparison, value, measurement, or other representation.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the disclosure. Since modifications, combinations, sub-combinations and variations of the disclosed embodiments incorporating the spirit and substance of the disclosure may occur to persons skilled in the art, the embodiments disclosed herein should be construed to include everything within the scope of the appended claims and their equivalents.

What is claimed is:

1. A coaxial cable connector for connecting a coaxial cable comprising an inner conductor, an insulator layer surrounding the inner conductor, an outer conductor layer surrounding the insulator layer and an outer jacket, the coaxial cable connector comprising:
a coupler comprising an inner surface defining a coupler inner bore;
a retainer comprising an inner surface defining a retainer inner bore configured to receive an inner conductor and insulator layer of a coaxial cable and an outer angled rear facing surface configured to extend between the insulator layer and the outer conductor layer of the coaxial cable, the retainer disposed within the inner bore of the coupler; and
a hub engaged to the retainer and disposed at least partially within the inner bore of the coupler, the hub rotatably engaged with the coupler, the hub further comprising an outer angled forward facing surface at least partially opposing the outer angled rear facing surface of the retainer,
wherein the outer angled rear facing surface of the retainer and the outer angled forward facing surface of the hub are configured to secure the outer conductor layer between the outer angled rear facing surface of the retainer and the outer angled forward facing surface of the hub.

2. The connector of claim 1 wherein the coaxial cable connector comprises:
a body comprising forward end a rear end and an inner surface defining a body inner bore extending longitudinally between the forward end and the rear end, the body engaged to the hub generally at the forward end of the body;
a collar comprising a forward end and a rear end and an inner surface defining a collar inner bore, the collar disposed at least partially outside the body and configured to move axially with respect to the body; and
a gripping member disposed within the collar inner bore at least partially adjacent to the rear end of the body.

3. The connector of claim 2 wherein the body comprises a first forward shoulder, a second rear shoulder and an outer surface extending between the first forward shoulder and the second forward shoulder, the first forward shoulder and second rear shoulder extending radially outwardly from the outer surface.

4. The connector of claim 3 wherein the collar comprises an inwardly extending flange disposed between the first forward shoulder and the second rear shoulder.

5. The connector of claim 4 wherein the collar is configured to slide longitudinally with respect to the body with the inwardly extending flange of the collar disposed between the first forward shoulder and second rear shoulder of the body.

6. The connector of claim 5 wherein the collar comprises a surface extending inwardly from the inner surface of the collar into the collar inner bore, the gripping member disposed adjacent the surface.

7. The connector of claim 6 wherein the surface of the collar is configured to move the gripping member at least partially into the body when the collar is moved longitudinally toward the body.

8. The connector of claim 6 wherein the gripping member is adapted to secure the outer jacket of the coaxial cable within the body.

9. The connector of claim 1 wherein the retainer comprises an outer annular groove disposed along an outer surface of the retainer and the hub comprises an inwardly extending flange engaged with the outer annular groove of the retainer.

10. The connector of claim 1 wherein the connector comprises an O-ring disposed between the coupler and body.

11. The connector of claim 1 wherein an extended portion of the coupler at least partially encircles a portion of the body.

12. The connector of claim 1 wherein the hub comprises an integral continuity element.

13. The connector of claim 1 wherein the retainer comprises a protrusion extending from the retainer, the protrusion configured to be interposed between the insulator layer and the outer conductor layer.

14. The connector of claim 1 wherein the hub comprises a plurality of slots each having at least two edges, the edges configured to frictionally engage the inner surface of the body.

15. The connector of claim 1 wherein the hub comprises at least one barb configured to frictionally engage the inner surface of the body.

16. The connector of claim 1 wherein a rear edge of the hub is flared to engage an inner surface of the body.

17. A method for securing a cable or conduit in a connector, the method comprising:
inserting a coaxial cable through inner bores of a collar, a gripping member, a body and a hub, an inner conductor and insulator of the coaxial cable extending through a retainer and an outer conductor of the coaxial cable extending between the retainer and the hub along a rearward facing edge of the retainer;
sliding the collar relative to the body, the collar comprising a surface extending inwardly from an inner surface of the collar, the surface disposed adjacent to and contacting a rear end of the gripping member, the collar surface pushing the gripping member at least partially into a rear end of the body.

18. The method of claim 17, wherein the body comprises a first forward shoulder, a second rear shoulder and an outer surface extending between the first forward shoulder and the second forward shoulder, the first forward shoulder and second rear shoulder extending radially outwardly from the outer surface.

19. The method of claim 18 wherein collar comprises an inwardly extending flange disposed between the first forward shoulder and the second rear shoulder.

20. The method of claim 19 wherein the collar is configured to slide longitudinally with respect to the body with the inwardly extending flange of the collar disposed between the first forward shoulder and second rear shoulder of the body.
